(19) United States
(12) Patent Application Publication
(10) Pub. No.: US 2009/0165029 A1
(43) Pub. Date: Jun. 25, 2009

(54) PORTABLE DISC PLAYER

(75) Inventor: SHI-KUN GUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/185,122

(22) Filed: Aug. 4, 2008

(30) Foreign Application Priority Data
Dec. 19, 2007 (CN) 200710203234.6

(51) Int. Cl. G11B 33/02

(52) U.S. Cl. 720/647

(57) ABSTRACT

A portable disc player includes a main body and a lid pivotally connected to the main body. The main body includes a cover, a base, and a traverse module. The traverse module is configured for reading information from or writing information to a disc. The cover and the base cooperatively fix the traverse module therebetween. The cover defines an opening for exposing the disc rotator. The traverse module includes a disc rotator for supporting and rotating the disc. A protrusion forms on a lower side of the lid corresponding to the disc rotator.

### BACKGROUND

1. Field of the Invention

The present invention generally relates to a portable disc player.

2. Description of Related Art

A commonly used portable disc player, such as a portable digital versatile disc (DVD) player, is normally a lid-type. A lid-type disc player includes generally a main body and a lid pivotally connected to the main body via a hinge assembly. The main body includes a receiving portion for receiving a disc, a spindle motor for rotating the disc, and a pickup head for reading information from, or writing information to, the disc. The lid is configured for protecting the pickup head and the disc when the disc is being rotated by the spindle motor.

However, under certain conditions, the lid may be used occasionally to support foreign objects, such as books, fruits, when the disc is being played by the disc player. When this happens, the lid may be deformed such that the under surface of the lid will be scratching the rotating disc. In addition, a friction is generated between the lower side of the lid and the disc, which resists the rotating of the disc and even damages the disc.

Therefore, an improved portable disc player is needed in the industry to address the aforementioned deficiency.

### SUMMARY

A portable disc player includes a main body and a lid pivotally connected to the main body. The main body includes a cover, a base, and a traverse module. The traverse module is configured for reading information from, or writing information to, a disc. The cover and the base cooperatively fix the traverse module therebetween. The cover defines an opening for exposing the disc rotator. The traverse module includes a disc rotator for supporting and rotating the disc. A protrusion forms on a lower side of the lid corresponding to the disc rotator.

Other advantages and novel features will become more apparent from the following detailed description of preferred embodiment when taken in conjunction with the accompanying drawings.

### BRIEF DESCRIPTION OF THE DRAWINGS

FIG. 1 is a schematic assembled view showing a portable disc player in accordance with an exemplary embodiment.

FIG. 2 is an exploded schematic view showing the portable disc player of FIG. 1.

FIG. 3 is a cross-sectional view of the portable disc player.

FIG. 4 is a partial enlarged view of the circled portion IV of FIG. 3.

FIG. 5 is a partial enlarged view of the circled portion IV of FIG. 3 when the portable disc player is pressed.

### DETAILED DESCRIPTION

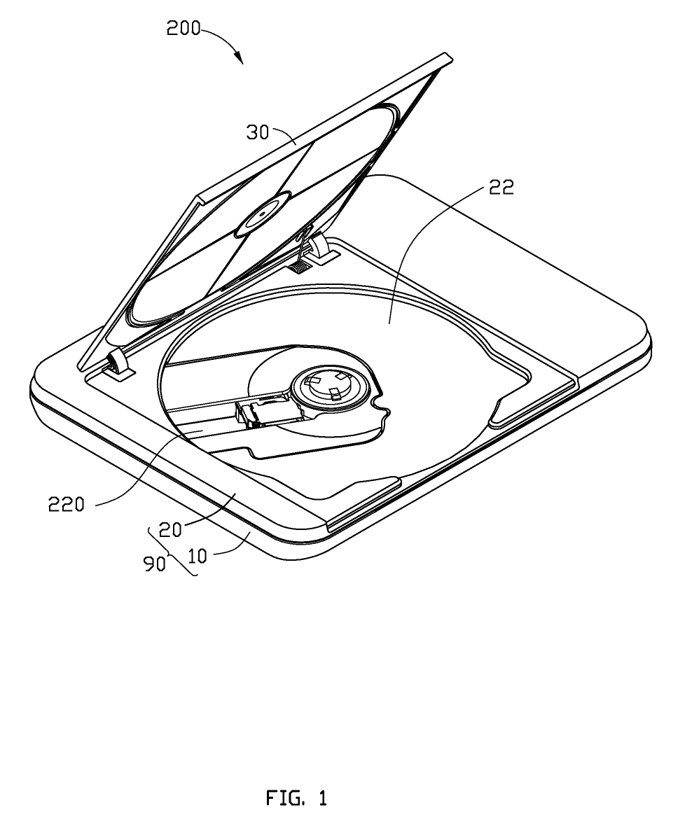

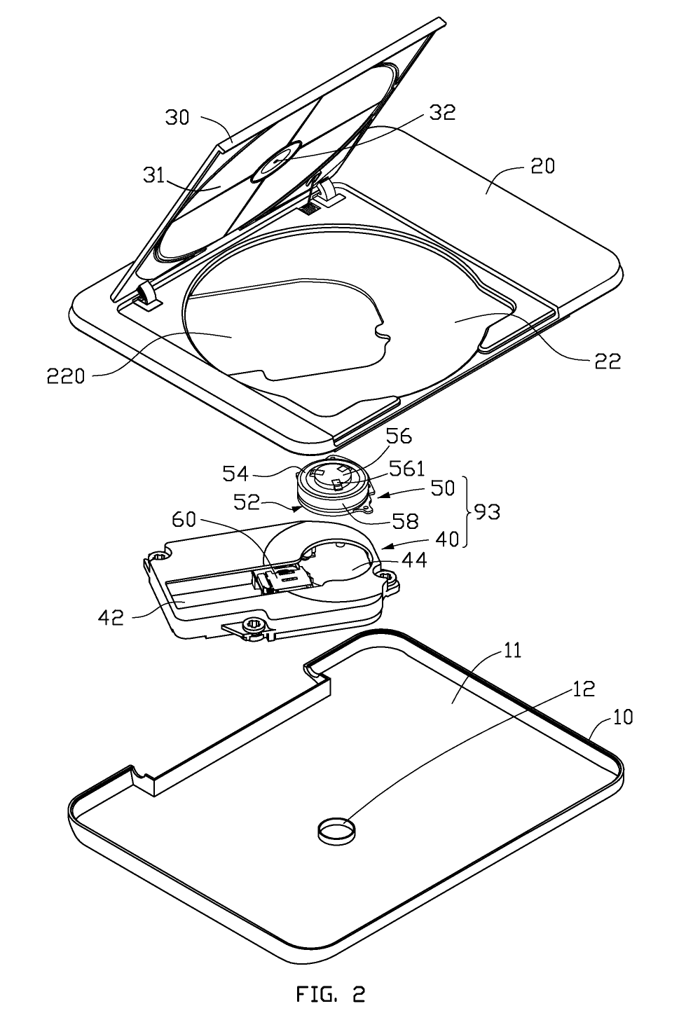

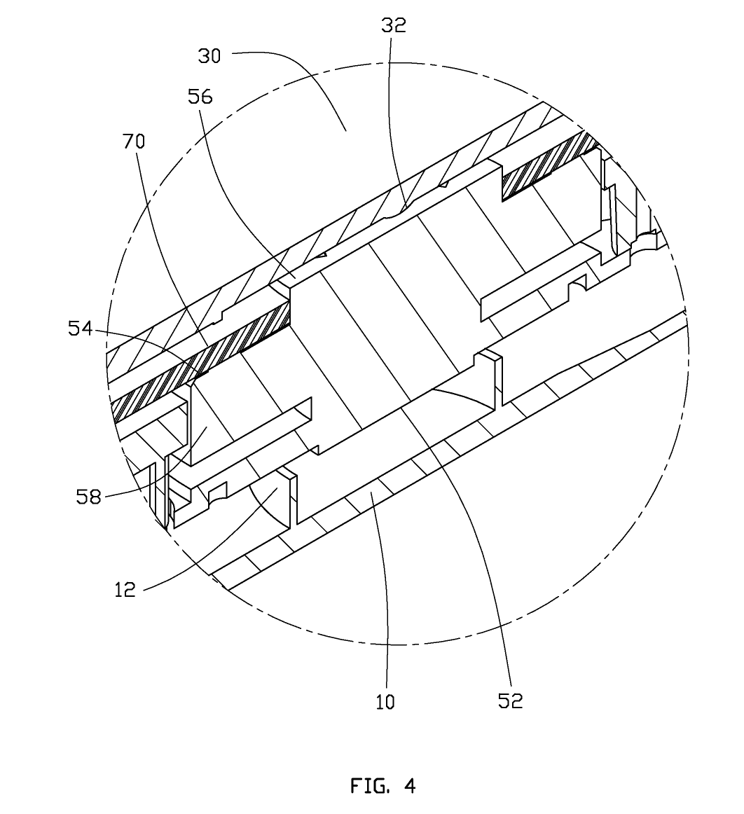

Referring to FIGS. 1 and 2, a portable disc player 200 in accordance with an exemplary embodiment includes a main body 90 and a lid 30 pivotally connected to the main body 90 via hinge assemblies (not labeled). The main body 90 includes a traverse module 93, a cover 20, and a base 10. The cover 20 and the base 10 cooperatively fix the traverse module 93 between them. The cover 20 defines a receiving portion 22 depressed in an outer surface of the cover 20 for receiving a disc 70 (see FIG. 4). The lid 30 is configured for covering the disc 70 in the receiving portion 22. The receiving portion 22 defines an opening 220 for partially exposing the traverse module 93. The traverse module 93 is configured for reading information from, or writing information to, the disc 70.

The traverse module 93 includes a bracket 40, a disc rotator 50, and a pickup head 60. The bracket 40 is configured for supporting the disc rotator 50 and the pickup head 60. The bracket 40 defines a rectangular slot 42 for allowing the pickup head 60 to slide therein, and a circular opening 44 for exposing the disc rotator 50.

The disc rotator 50 includes a supporting part 52, a spindle motor 58, a turntable 54, and a damper 56. The supporting part 52 is fixed to the bracket 40, and is configured for supporting the spindle motor 58. The spindle motor 58 is connected to the supporting part 52 for rotating the turntable 54. The turntable 54 is connected to a rotor (not shown) of the spindle motor 58 and is configured for loading and rotating the disc 70. The damper 56 is fixed on the turntable 54 and capable of releasably clamping the disc 70 on the turntable 54 via three flexible clamping members 561.

The lid 30 includes a lower side 31. A protrusion 32 is formed in the lower side 31 of the lid 30 corresponding to the disc rotator 50. The base 10 includes an inner side 11. A supporting member 12 extends upwardly from the inner side 11 towards the disc rotator 50. For example, the supporting member 12 is a hollow cylinder. The protrusion 32, the disc rotator 50, and the supporting member 12 are disposed correspondingly with their centers being at an imaginary line (not shown). A diameter of the protrusion 32 is smaller than that of the damper 56.

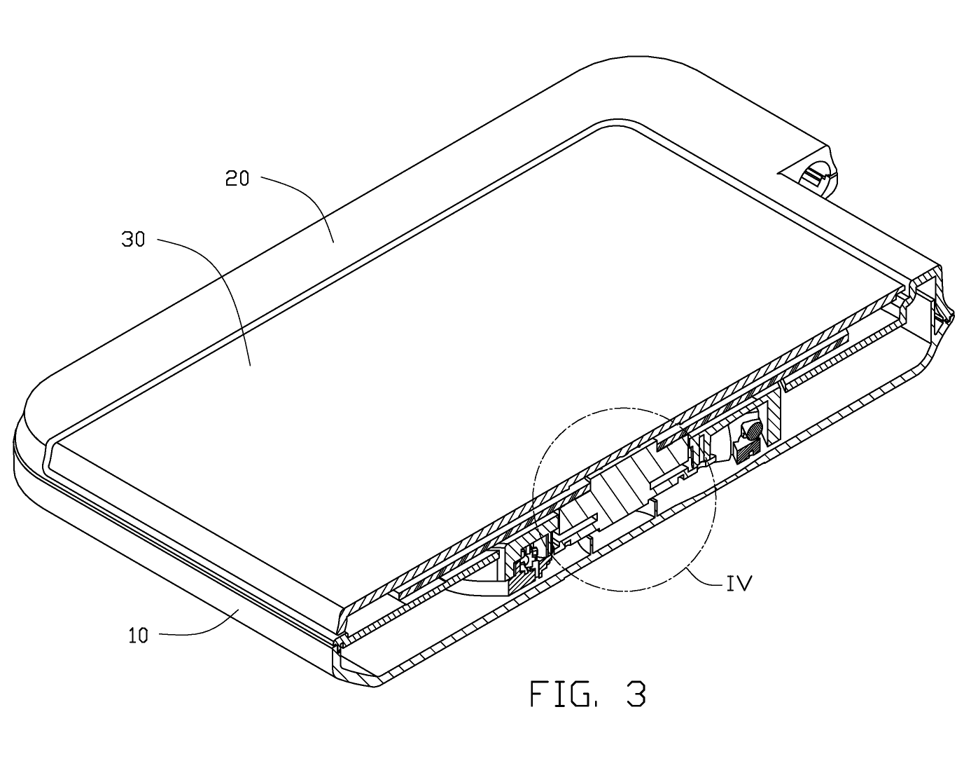

Also referring to FIGS. 3 and 4, after assembly, the traverse module 93 is fixed between the cover 20 and the base 10. The disc rotator 50 and the pickup head 60 are exposed through the opening 220 of the receiving portion 22. The disc 70 is received in the receiving portion 22, and is loaded on the turntable 54. The protrusion 32 of the lid 30 is above the damper 56. The supporting part 52 of the disc rotator 50 is above the supporting member 12 of the base 10.

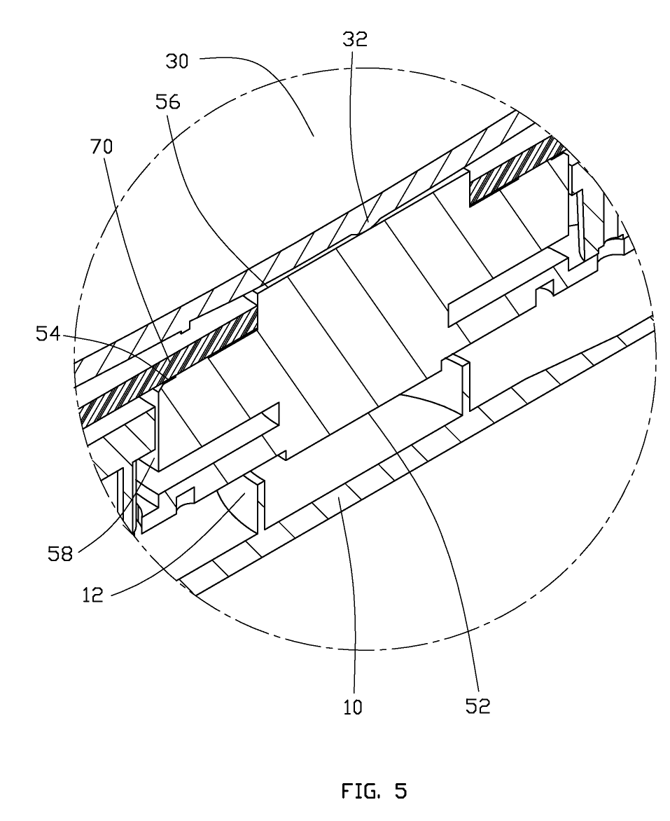

Referring also to FIG. 5, when the lid 30 is pressed, the lid 30 becomes deformed. The protrusion 32 of the lid pushes on the top of the damper 56, and the disc rotator 50 is pushed towards the base 10. The supporting member 12 will support the supporting part 52 of the disc rotator 50. Therefore, other parts of the lid 30 are prevented from touching the disc 70, and the disc 70 will be protected by the protrusion 32. Furthermore, the supporting member 12 is also used for supporting the disc rotator 50, to avoid a deformation of the bracket 40, and further to keep a stable operation of the pickup head 60.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable disc player comprising:
a main body comprising:
a traverse module configured for reading information from, or writing information to, a disc, the traverse module comprising a disc rotator configured for supporting and rotating the disc; and
a cover and a base cooperatively fixing the traverse module therebetween, wherein the cover defines an opening for exposing the disc rotator;
a lid pivotally connected to the main body, wherein a protrusion is formed on a side of the lid facing and corresponding to the disc rotator.

2. The portable disc player according to claim 1, wherein the disc rotator comprises a turntable configured for loading and rotating the disc and a damper fixed on the turntable for releasably clamping the disc on the turntable.

3. The portable disc player according to claim 2, wherein a diameter of the protrusion is smaller than that of the clamper.

4. The portable disc player according to claim 3, wherein a supporting member extends upwardly from an inner side of the base.

5. The portable disc player according to claim 4, wherein the protrusion, the disc rotator, and the supporting member are disposed correspondingly.

6. The portable disc player according to claim 4, wherein the disc rotator further comprises a supporting part fixed to the traverse module and a spindle motor connected to the supporting part, and the spindle motor is configured for rotating the turntable.

7. The portable disc player according to claim 1, wherein the traverse module further comprises a pickup head and a bracket, and the bracket is configured for supporting the disc rotator and the pickup head.

8. The portable disc player according to claim 7, wherein the bracket defines a rectangular slot configured for allowing the pickup head to slide therein, and a circular opening configured for exposing the disc rotator.

9. A portable disc player comprising:
a disc rotator configured for rotating a disc; and
a lid configured for covering the disc when the disc is rotated;
wherein a protrusion is formed on a lower side of the lid facing and corresponding to the disc rotator.

10. The portable disc player according to claim 9, wherein the disc rotator comprises a turntable configured for loading and rotating the disc and a damper fixed on the turntable and configured for releasably clamping the disc on the turntable.

11. The portable disc player according to claim 10, wherein the disc rotator further comprises a spindle motor configured for rotating the turntable and a supporting part for supporting the spindle motor.

12. The portable disc player according to claim 11, further comprising a cover and a base cooperatively fixing the disc rotator, and the lid is pivotally connected to the cover.

13. The portable disc player according to claim 12, wherein the cover defining an opening for exposing the disc rotator.

14. The portable disc player according to claim 12, wherein a supporting member extends upwardly from an inner side of the base.

15. The portable disc player according to claim 14, wherein the protrusion, the disc rotator, and the supporting member are disposed correspondingly.

16. The portable disc player according to claim 9, wherein the protrusion is capable of resisting on the disc rotator when the lid is pressed towards the disc.
